(19) United States
(12) Patent Application Publication
(10) Pub. No.: US 2018/0237547 A1
(43) Pub. Date: Aug. 23, 2018

(54) WHITE POLYMER DISPERSION

(71) Applicant: BASF SE, Ludwigshafen (DE)

(72) Inventors: Nico VELING, Heidelberg (DE); Dirk LAWRENZ, Hassloch (DE); Stefan WEBER, Einhausen (DE); Peter WACHTLER, Wien (AT)

(73) Assignee: BASF SE, Ludwigshafen (DE)

(21) Appl. No.: 15/753,649

(22) PCT Filed: Aug. 19, 2016
(86) PCT No.: PCT/EP2016/069734

§ 371 Date: Feb. 20, 2018

(30) Foreign Application Priority Data
Aug. 25, 2015 (EP) 15182360.6

(51) Int. Cl. C08F 2/20; C08F 236/10; C08F 220/18; C08L 3/02; C08L 9/06; C08F 8/04

(52) U.S. Cl. CPC C08F 2/20; C08F 236/10; C08F 220/18; D21H 19/54; C08L 9/06; C08F 8/04; C08F 2800/20; C08L 3/02

(57) ABSTRACT

The present invention refers to a process for the preparation of an aqueous polymer dispersion, an aqueous polymer dispersion obtained by the process, a binder, an adhesive, a size suitable for at least one fiber, a covering, or a paper coating slip, comprising the aqueous polymer dispersion as well as the use of the aqueous polymer dispersion for the preparation of a binder, an adhesive, a size suitable for at least one type of fiber, a paint, a covering, or a paper coating slip.

### FIELD OF THE INVENTION

The present invention refers to a process for the preparation of an aqueous polymer dispersion, an aqueous polymer dispersion obtained by the process, a binder, an adhesive, a size suitable for at least one type of fiber, a covering, or a paper coating slip, comprising the aqueous polymer dispersion as well as the use of the aqueous polymer dispersion for the preparation of a binder, an adhesive, a size suitable for at least one type of fiber, a paint, a covering, or a paper coating slip.

### BACKGROUND OF THE INVENTION

Copolymers of vinyl aromatic compounds and monomers such as ethylenically unsaturated acids, conjugated aliphatic dienes and/or acrylates, which are prepared in the presence of carbohydrate compounds, and aqueous dispersions thereof are well known and may be used in a great variety of applications such as for binders, adhesives, sizes, paints, coverings, or paper coating slips.

The properties of such copolymers are still not entirely satisfactory. In particular, aqueous polymer dispersions of copolymers of vinyl aromatic compounds and further monomers need a special treatment in order to provide a certain stability against mechanical and chemical influences. For example, such stable polymer dispersions can be prepared by using protective colloids which are adsorbed on the polymer particle surface. Typical protective colloids are for example starch derivatives.

EP-A 0 536 597 discloses aqueous polymer dispersions which are obtainable by free radical emulsion polymerization of unsaturated monomers in the presence of at least one starch degradation product which is prepared by hydrolysis of native starch or chemically modified starch in the aqueous phase and has a weight average molecular weight Mw of from 2500 to 25000. For example, monomer mixtures which comprise from 50 to 100% by weight of esters of acrylic acid and/or methacrylic acid with alcohols having 1 to 12 carbon atoms and/or styrene or from 70 to 100% by weight of styrene and/or butadiene are used as unsaturated monomers. The polymer dispersions are used as a binder, adhesive, size for fibers or for the production of coverings.

WO 99/09251 discloses a starch-copolymer product and a process for its preparation. The starch-copolymer product can be considered as a reaction product of starch and at least one monomer which is capable of free radical polymerization. In order to prepare aqueous dispersions of such products, an aqueous solution or dispersion of a degraded starch which has an intrinsic viscosity of from 0.07 to 0.35 dl/g in aqueous solution at a temperature of 25° C. is used. The polymerization is carried out in such a way that first a part of the monomers and of the free radical initiator is added to the aqueous solution or dispersion of the degraded starch, which solution or dispersion has been heated to the polymerization temperature, and, after the polymerization has started, further portions of monomers and initiator are metered in, at least 75% of the total monomers being added after more than one hour after the initiation of the polymerization. The dispersions are used for the production of coverings and as binders for paper products.

WO 03/091300 discloses aqueous polymer dispersions which are obtainable by free radical copolymerization of (a) from 0.1 to 99.9% by weight of styrene and/or methylstyrene, (b) from 0.1 to 99.9% by weight of 1,3-butadiene and/or isoprene and (c) from 0 to 40% by weight of other ethylenically unsaturated monomers, the sum of the monomers (a), (b) and (c) being 100, in the presence of from 10 to 40% by weight, based on the monomers used, of at least one degraded starch having a molecular weight Mn of from 500 to 40000 and a water-soluble redox catalyst. These polymer dispersions are used as engine sizes and surface sizes for paper, board and cardboard.

WO 2010/060863 A1 discloses a process for preparing an aqueous polymer dispersion, the process comprising copolymerizing monomers comprising (a) at least one vinylaromatic compound, (b) at least one conjugated aliphatic diene, and (c) at least one ethylenically unsaturated carbonitrile, in an aqueous medium as a polymerization mixture, in the presence of a degraded starch and of at least one free radical initiator, wherein at least a part of monomers differing from ethylenically unsaturated carbonitriles are polymerized before the ethylenically unsaturated carbonitriles are added to the polymerization mixture.

However, aqueous polymer dispersions of copolymers of vinyl aromatic compounds and further monomers, which are stabilized by starch derivatives, have the disadvantage that they often show a brownish or grayish discoloration when they are neutralized to pH values around 7 at higher temperatures. Such discoloration is also visible in formulations made from such aqueous polymer dispersions such as binders, adhesives, sizes, paints, coverings, or paper coating slips. Thus, a reduction in quality is typically the result for applications in which a high degree of whiteness is desired such as for paints and paper coating slips.

Therefore, there is a need in the art for providing a process which avoids the foregoing disadvantages and especially allows for the preparation of an pH neutral aqueous polymer dispersion at elevated temperatures, being stabilized by a starch derivative, and providing very well optical characteristics to the aqueous polymer dispersion as well as the resulting end formulation/application. In particular, it is desirable to provide a process for the preparation of an aqueous polymer dispersion which enables high CIE whiteness in the various application fields.

Accordingly, it is an object of the present invention to provide a process for the preparation of an aqueous polymer dispersion. Furthermore, it is an object of the present invention to provide a process in which the aqueous polymer dispersion is stabilized by a starch derivative. It is an even further object of the present invention to provide a process in which the optical properties of the resulting aqueous polymer dispersion are improved. Another object of the present invention is to provide a process in which the whiteness of the resulting aqueous polymer dispersion is improved. An even further object of the present invention to provide a process in which the optical properties, especially the CIE whiteness, of the formulation/application resulting from the aqueous polymer dispersion are improved. Further objects can be gathered from the following description of the invention.

### SUMMARY OF THE INVENTION

The foregoing and other objects are solved by the subject-matter of the present invention. According to a first aspect of the present invention, a process for the preparation of an aqueous polymer dispersion is provided. The process comprises at least the steps of:
a) copolymerizing of
   i) at least one vinyl aromatic compound, and/or
   ii) at least one ethylenically unsaturated acid, and/or
   iii) at least one conjugated aliphatic diene, and/or
   iv) at least one acrylate monomer selected from C1-C10 alkyl acrylates and C1-C10 alkyl methacrylates, and/or
   v) at least one unsaturated nitrogen containing compound,
   in an aqueous medium in the presence of at least one degraded starch and of free radical initiators, and,
b) adding at least one reducing agent to the polymerization mixture of step a).

The inventors surprisingly found out that a process for the preparation of an aqueous polymer dispersion as defined herein, namely a process comprising at least steps a) and b), provides an aqueous polymer dispersion which is stabilized by a starch derivative and further has improved optical properties, especially improved whiteness.

According to another aspect of the present invention, an aqueous polymer dispersion obtained by the process is provided.

According to a further aspect of the present invention, a binder, an adhesive, a size suitable for at least one type of fiber, a paint, a covering, or a paper coating slip, comprising the aqueous polymer dispersion, as defined herein, is provided.

According to an even further aspect of the present invention, the use of the aqueous polymer dispersion, as defined herein, for the preparation of a binder, an adhesive, a size suitable for at least one type of fiber, a paint, a covering, or a paper coating slip is provided.

Advantageous embodiments of the inventive process for the preparation of an aqueous polymer dispersion are defined in the corresponding sub-claims.

According to one embodiment, the vinyl aromatic compound is selected from the group comprising styrene, α-methylstyrene, vinyltoluene and mixtures thereof, and/or the at least one ethylenically unsaturated acid is selected from the group comprising acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, vinylphosphonic acid, salts thereof and mixtures thereof, and/or the at least one conjugated aliphatic diene is selected from the group comprising 1,3-butadiene, isoprene, 1,3-pentadiene, dimethyl-1,3-butadiene, cyclopentadiene and mixtures thereof, and/or the at least one acrylate monomer is selected from the group comprising methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, sec-butyl acrylate, sec-butyl methacrylate, tert-butyl acrylate, tert-butyl methacrylate, pentyl acrylates, pentyl methacrylates, 2-ethylhexyl acrylate, 2-ethylhexyl methacrylate, propylheptyl acrylate and mixtures thereof and/or the at least one unsaturated nitrogen containing monomer is selected from the group comprising acrylamide, methacrylamide, diacetonacrylamide, acrylonitrile, methacrylonitrile, fumarnitrile and mixtures thereof.

According to another embodiment, in step a)
i) 19.9 to 80% by weight, based on the total weight of monomers, of at least one vinyl aromatic compound, and/or
ii) 0.1 to 10% by weight, based on the total weight of monomers, of at least one ethylenically unsaturated acid, and/or
iii) 19.9 to 80% by weight, based on the total weight of monomers, of at least one conjugated aliphatic diene, and/or
iv) 19.9 to 80% by weight, based on the total weight of monomers, of at least one acrylate monomer selected from C1-C10 alkyl acrylates and C1-C10 alkyl methacrylates, and/or
v) 0 to 15% by weight, based on the total weight of monomers, of at least one unsaturated nitrogen containing monomer,

the sum of the % by weight of the monomers i), ii), iii), iv) and v) always being 100, are copolymerized.

According to one embodiment, the degraded starch comprises a degraded native starch having an intrinsic viscosity ηi of less than 0.07 dl/g.

According to another embodiment, the at least one degraded starch is present in an amount from 15 to 80% by weight, based on the total weight of monomers.

According to one embodiment the at least one reducing agent is added into the polymer dispersion obtained in step a) after the copolymerization is completed.

According to another embodiment, the at least one reducing agent is selected from the group comprising sodium metabisulfite, sodium bisulfite, sodium dithionite, sodium hydroxymethylsulfinate, formamidinesulfinic acid, acetone sodium bisulfite, sodium hydrosulfite, sodium sulfite and mixtures thereof.

According to yet another embodiment, the polymer dispersion obtained in step b) is adjusted to a pH in the range from 5 to 8.

According to one embodiment, the aqueous polymer dispersion obtained in step b) has a solids content of greater than 45% by weight, based on the total weight of the polymer dispersion.

According to yet another embodiment, the aqueous polymer dispersion obtained in step b), when coated on a base paper with CIE brightness level of 90 to 100 in an application weight of 19 g/m² provides a decrease of CIE whiteness of less than 5 units, measured according to ISO 2469.

In the following, the details and preferred embodiments of the inventive process will be described in more detail. It is to be understood that these technical details and embodiments also apply to the inventive products and use.

### DETAILED DESCRIPTION OF THE INVENTION

According to step a) of the instant process
i) at least one vinyl aromatic compound, and/or
ii) at least one ethylenically unsaturated acid, and/or
iii) at least one conjugated aliphatic diene, and/or
iv) at least one acrylate monomer selected from C1-C10 alkyl acrylates and C1-C10 alkyl methacrylates, and/or
v) at least one unsaturated nitrogen containing compound

are copolymerized in an aqueous medium in the presence of at least one degraded starch and of free radical initiators.

The term “at least one” means that the monomer comprises, preferably consists of, one or more monomer(s) of the respective group.

Suitable monomers of group (i) are at least one vinyl aromatic compound, e.g. styrene, α-methylstyrene and/or vinyltoluene. From this group of monomers, styrene is preferably used. The monomer mixture in the copolymerization comprises, for example, from 19.9 to 80% by weight, preferably from 25 to 70% by weight and most preferably from 40 to 65% by weight, based on the total weight of monomers, of at least one monomer of group (i).

In one embodiment, the at least one vinyl aromatic compound comprises, preferably consists of, one vinyl aromatic compound. Alternatively, the at least one vinyl aromatic compound comprises, preferably consists of, two or more vinyl aromatic compounds. For example, the at least one vinyl aromatic compound comprises, preferably consists of, two or three vinyl aromatic compounds.

Preferably, the at least one vinyl aromatic compound comprises, more preferably consists of, one vinyl aromatic compound. Most preferably, the at least one vinyl aromatic compound comprises, more preferably consists of, styrene.

Additionally or alternatively, monomers of group (ii) are at least one ethylenically unsaturated acid, for example, ethylenically unsaturated carboxylic acids, ethylenically unsaturated sulfonic acids and vinylphosphonic acid. Preferably used ethylenically unsaturated carboxylic acids are α,β-monoethylenically unsaturated mono- and dicarboxylic acids having 3 to 6 carbon atoms in the molecule. Examples of these are acrylic acid, methacrylic acid, itaconic acid, maleic acid, fumaric acid, crotonic acid, vinylacetic acid and vinyllactic acid. Suitable ethylenically unsaturated sulfonic acids are, for example, vinylsulfonic acid, styrene sulfonic acid, acrylamidomethylpropanesulfonic acid, sulfopropyl acrylate and sulfopropyl methacrylate. Ethylenically unsaturated carboxylic acids are preferred.

The monomers of group (ii) which comprise acid groups can be used in the polymerization in the form of the free acids and in the form partly or completely neutralized with suitable bases. Sodium hydroxide solution or potassium hydroxide solution or ammonia is preferably used as the neutralizing agent. The monomer mixture in the copolymerization comprises, for example, from 0.1 to 10% by weight, preferably from 0.1 to 8% by weight or from 1 to 6% by weight, based on the total weight of monomers, of at least one monomer of group (ii)

In one embodiment, the at least one ethylenically unsaturated acid comprises, preferably consists of, one ethylenically unsaturated acid. Alternatively, the at least one ethylenically unsaturated acid comprises, preferably consists of, two or more ethylenically unsaturated acids. For example, the at least one ethylenically unsaturated acid comprises, preferably consists of, two or three ethylenically unsaturated acid. In other words, if the at least one ethylenically unsaturated acid comprises, preferably consists of, two or more ethylenically unsaturated acids, the at least one ethylenically unsaturated acid comprises, preferably consists of, a mixture of different ethylenically unsaturated acids.

Preferably, the at least one ethylenically unsaturated acid comprises, more preferably consists of, two ethylenically unsaturated acids. In one embodiment, the at least one ethylenically unsaturated acid comprises, more preferably consists of, itaconic acid and acrylic acid.

In one embodiment, the at least one ethylenically unsaturated acid comprises, more preferably consists of, one ethylenically unsaturated acid. In one embodiment, the at least one ethylenically unsaturated acid comprises, more preferably consists of, itaconic acid or acrylic acid.

Additionally or alternatively, monomers of group (iii) are at least one conjugated aliphatic diene, for example, 1,3-butadiene, isoprene, 1,3-pentadiene, 1,3-dimethylbutadiene and cyclopentadiene. From this group of monomers, 1,3-butadiene and/or isoprene are preferably used. More preferably, 1,3-butadiene is used. The monomer mixture in the copolymerization comprises, for example, from 19.9 to 80% by weight, preferably from 25 to 70% by weight and most preferably from 25 to 50% by weight, based on the total weight of monomers, of at least one monomer of group (iii).

In one embodiment, the at least one conjugated aliphatic diene comprises, preferably consists of, one conjugated aliphatic diene. Alternatively, the at least one conjugated aliphatic diene comprises, preferably consists of, two or more conjugated aliphatic dienes. For example, the at least one conjugated aliphatic diene comprises, preferably consists of, two or three conjugated aliphatic dienes.

Preferably, the at least one conjugated aliphatic diene comprises, more preferably consists of, one conjugated aliphatic diene. Most preferably, the at least one conjugated aliphatic diene comprises, more preferably consists of, one 1,3-butadiene.

Additionally or alternatively, monomers of group (iv) are at least one acrylate monomer being selected from C1-C10 alkyl acrylates and C1-C10 alkyl methacrylates. So the acrylate monomers in question comprise esters of acrylic acid and of methacrylic acid with monohydric C1-010 alcohols such as, for example, methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, sec-butyl acrylate, sec-butyl methacrylate, tert-butyl acrylate, tert-butyl methacrylate, pentyl acrylates, pentyl methacrylates, 2-ethylhexyl acrylate, 2-ethylhexyl methacrylate or propylheptyl acrylate. The acrylate monomers are preferably selected from C1-C8 alkyl acrylates and C1-C8 alkyl methacrylates, more particularly from methyl acrylate, ethyl acrylate, n-butyl acrylate, ethylhexyl acrylate, propylheptyl acrylate and their mixture. n-Butyl acrylate is particularly preferred. The monomer mixture in the copolymerization comprises, for example, from 19.9 to 80% by weight, preferably from 25 to 70% by weight and most preferably from 25 to 60% by weight, based on the total weight of monomers, of at least one monomer of group (iv).

In one embodiment, the at least one acrylate monomer comprises, preferably consists of, one acrylate monomer. Alternatively, the at least one acrylate monomer comprises, preferably consists of, two or more acrylate monomers. For example, the at least one acrylate monomer comprises, preferably consists of, two or three acrylate monomers.

Preferably, the at least one acrylate monomer comprises, more preferably consists of, one acrylate monomer. Most preferably, the at least one acrylate monomer comprises, more preferably consists of, n-butyl acrylate.

Additionally or alternatively, monomers of group (v) are at least one unsaturated nitrogen containing compound. So the unsaturated nitrogen containing compounds in question comprise monomers of nitrils and/or acrylamide, such as, for example, acrylamide, methacrylamide, diacetonacrylamide, acrylonitrile, methacrylonitrile, fumarnitrile and mixtures thereof. The at elast one unsaturated nitrogen containing compound is preferably selected from acrylamide, methacrylamide, acrylonitrile, methacrylonitrile and mixtures thereof. Acrylamide and/or acrylonitrile is/are particularly preferred. The monomer mixture in the copolymerization comprises, for example, from 0 to 15% by weight, preferably from 1 to 15% by weight and most preferably from 2 to 10% by weight, based on the total weight of monomers, of at least one monomer of group (v).

In one embodiment, the at least one unsaturated nitrogen containing monomer comprises, preferably consists of, one unsaturated nitrogen containing monomer. Alternatively, the at least one unsaturated nitrogen containing monomer comprises, preferably consists of, two or more unsaturated nitrogen containing monomers. For example, the at least one unsaturated nitrogen containing monomer comprises, preferably consists of, two or three unsaturated nitrogen containing monomers.

Preferably, the at least one unsaturated nitrogen containing monomer comprises, more preferably consists of, one unsaturated nitrogen containing monomer. Most preferably, the at least one unsaturated nitrogen containing monomer comprises, more preferably consists of, acrylamide or acrylonitrile.

In one embodiment of the instant process,
i) 19.9 to 80% by weight, based on the total weight of monomers, of at least one vinyl aromatic compound, and/or
ii) 0.1 to 10% by weight, based on the total weight of monomers, of at least one ethylenically unsaturated acid, and/or
iii) 19.9 to 80% by weight, based on the total weight of monomers, of at least one conjugated aliphatic diene, and/or
iv) 19.9 to 80% by weight, based on the total weight of monomers, of at least one acrylate monomer selected from C1-C10 alkyl acrylates and C1-C10 alkyl methacrylates, and/or
v) 0 to 15% by weight, based on the total weight of monomers, of at least one unsaturated nitrogen containing monomer,

the sum of the % by weight of the monomers i), ii), iii), iv) and v) always being 100, are copolymerized.

For example,
i) 19.9 to 80% by weight, based on the total weight of monomers, of at least one vinyl aromatic compound, and
ii) 0.1 to 10% by weight, based on the total weight of monomers, of at least one ethylenically unsaturated acid, and
iii) 19.9 to 80% by weight, based on the total weight of monomers, of at least one conjugated aliphatic diene, and
iv) 19.9 to 80% by weight, based on the total weight of monomers, of at least one acrylate monomer selected from C1-C10 alkyl acrylates and C1-C10 alkyl methacrylates, and
v) 0 to 15% by weight, based on the total weight of monomers, of at least one unsaturated nitrogen containing monomer,

the sum of the % by weight of the monomers i), ii), iii), iv) and v) always being 100, are copolymerized.

Alternatively,
i) 19.9 to 80% by weight, based on the total weight of monomers, of at least one vinyl aromatic compound, or
ii) 0.1 to 10% by weight, based on the total weight of monomers, of at least one ethylenically unsaturated acid, or
iii) 19.9 to 80% by weight, based on the total weight of monomers, of at least one conjugated aliphatic diene, or
iv) 19.9 to 80% by weight, based on the total weight of monomers, of at least one acrylate monomer selected from C1-C10 alkyl acrylates and C1-C10 alkyl methacrylates, or
v) 0 to 15% by weight, based on the total weight of monomers, of at least one unsaturated nitrogen containing monomer,

the sum of the % by weight of the monomers i), ii), iii), iv) and v) always being 100, are copolymerized.

Preferably,
i) 19.9 to 80% by weight, based on the total weight of monomers, of at least one vinyl aromatic compound, and
ii) 0.1 to 10% by weight, based on the total weight of monomers, of at least one ethylenically unsaturated acid, and
iii) 19.9 to 80% by weight, based on the total weight of monomers, of at least one conjugated aliphatic diene, or
iv) 19.9 to 80% by weight, based on the total weight of monomers, of at least one acrylate monomer selected from C1-C10 alkyl acrylates and C1-C10 alkyl methacrylates, and
v) 0 to 15% by weight, based on the total weight of monomers, of at least one unsaturated nitrogen containing monomer,

the sum of the % by weight of the monomers i), ii), iii), iv) and v) always being 100, are copolymerized.

In one embodiment of the instant process,
i) 19.9 to 80% by weight, based on the total weight of monomers, of styrene and/or methylstyrene, and
ii) 0.1 to 10% by weight, based on the total weight of monomers, of acrylic acid and/or methacrylic acid and/or itaconic acid, and
iii) 19.9 to 80% by weight, based on the total weight of monomers, of 1,3-butadiene and/or isoprene, and
v) 0 to 15% by weight, based on the total weight of monomers, of acrylamide and/or acrylonitrile,

the sum of the % by weight of the monomers i), ii), iii) and v) always being 100,

are copolymerized in an aqueous medium in the presence of at least one degraded starch and of free radical initiators.

For example, the instant process is carried out in that
i) 19.9 to 80% by weight, based on the total weight of monomers, of styrene, and
ii) 0.1 to 10% by weight, based on the total weight of monomers, of acrylic acid and itaconic acid, and
iii) 19.9 to 80% by weight, based on the total weight of monomers, of 1,3-butadiene, and
v) 0 to 15% by weight, based on the total weight of monomers, of acrylamide and/or acrylonitrile,
the sum of the % by weight of the monomers i), ii), iii) and v) always being 100,

are copolymerized in an aqueous medium in the presence of at least one degraded starch and of free radical initiators.

In one embodiment, the instant process is carried out in that
i) 19.9 to 80% by weight, based on the total weight of monomers, of styrene, and
ii) 0.1 to 10% by weight, based on the total weight of monomers, of acrylic acid or itaconic acid, and
iii) 19.9 to 80% by weight, based on the total weight of monomers, of 1,3-butadiene, and
v) 0 to 15% by weight, based on the total weight of monomers, of acrylamide and/or acrylonitrile,
the sum of the % by weight of the monomers i), ii), iii) and v) always being 100,

are copolymerized in an aqueous medium in the presence of at least one degraded starch and of free radical initiators.

For example, the instant process is carried out in that
i) 19.9 to 80% by weight, based on the total weight of monomers, of styrene, and
ii) 0.1 to 10% by weight, based on the total weight of monomers, of acrylic acid or itaconic acid, and
iii) 19.9 to 80% by weight, based on the total weight of monomers, of 1,3-butadiene,
the sum of the % by weight of the monomers i), ii) and iii) always being 100,

are copolymerized in an aqueous medium in the presence of at least one degraded starch and of free radical initiators.

Alternatively, the instant process is carried out in that
i) 19.9 to 80% by weight, based on the total weight of monomers, of styrene, and
ii) 0.1 to 10% by weight, based on the total weight of monomers, of acrylic acid or itaconic acid, and
iii) 19.9 to 80% by weight, based on the total weight of monomers, of 1,3-butadiene, and
v) 1 to 15% by weight, based on the total weight of monomers, of acrylamide and/or acrylonitrile,
the sum of the % by weight of the monomers i), ii), iii) and v) always being 100,

are copolymerized in an aqueous medium in the presence of at least one degraded starch and of free radical initiators.

In one embodiment, the instant process is carried out such that
i) 19.9 to 80% by weight, based on the total weight of monomers, of styrene and/or methylstyrene, and
ii) 0.1 to 10% by weight, based on the total weight of monomers, of acrylic acid and/or methacrylic acid and/or itaconic acid, and
iv) 19.9 to 80% by weight, based on the total weight of monomers, of ethyl acrylate and/or n-butyl acrylate, and
v) 0 to 15% by weight, based on the total weight of monomers, of acrylamide and/or acrylonitrile,
the sum of the % by weight of the monomers i), ii), iv) and v) always being 100,

are copolymerized in an aqueous medium in the presence of at least one degraded starch and of free radical initiators.

For example, the instant process is carried out such that
i) 19.9 to 80% by weight, based on the total weight of monomers, of styrene, and
ii) 0.1 to 10% by weight, based on the total weight of monomers, of acrylic acid and/or itaconic acid, and
iv) 19.9 to 80% by weight, based on the total weight of monomers, of n-butyl acrylate,
v) 0 to 15% by weight, based on the total weight of monomers, of acrylamide and/or acrylonitrile,
the sum of the % by weight of the monomers i), ii), iv) and v) always being 100,

are copolymerized in an aqueous medium in the presence of at least one degraded starch and of free radical initiators.

In one embodiment, the instant process is carried out such that
i) 19.9 to 80% by weight, based on the total weight of monomers, of styrene, and
ii) 0.1 to 10% by weight, based on the total weight of monomers, of acrylic acid and/or itaconic acid, and
iv) 19.9 to 80% by weight, based on the total weight of monomers, of n-butyl acrylate,
the sum of the % by weight of the monomers i), ii) and iv) always being 100,

are copolymerized in an aqueous medium in the presence of at least one degraded starch and of free radical initiators.

Alternatively, the instant process is carried out such that
i) 19.9 to 80% by weight, based on the total weight of monomers, of styrene, and
ii) 0.1 to 10% by weight, based on the total weight of monomers, of acrylic acid and/or itaconic acid, and
iv) 19.9 to 80% by weight, based on the total weight of monomers, of n-butyl acrylate,
v) 1 to 15% by weight, based on the total weight of monomers, of acrylamide and/or acrylonitrile,
the sum of the % by weight of the monomers i), ii), iv) and v) always being 100,

are copolymerized in an aqueous medium in the presence of at least one degraded starch and of free radical initiators.

The polymer dispersions of the present invention are preferably prepared in a heatable reactor equipped with a mixing device.

The instant process for the preparation of an aqueous polymer dispersion is carried out in an aqueous medium.

The term “aqueous” medium refers to a system in which the solvent comprises, preferably consists of, water. However, it is to be noted that said term does not exclude that the solvent comprises minor amounts of a water-miscible organic solvent selected from the group comprising methanol, ethanol, acetone, acetonitrile, tetrahydrofuran, glycerol, ethylenglycol, polyethylenglykol of different molecular weight, and mixtures thereof. If the solvent comprises a water-miscible organic solvent, the water-miscible organic solvent is present in an amount from 0.01 to 30.0 wt.-%, preferably from 0.01 to 20.0 wt.-%, more preferably from 0.01 to 15.0 wt.-% and most preferably from 0.01 to 10.0 wt.-%, based on the total weight of the solvent. For example, the solvent of the aqueous medium consists of water. If the solvent of the aqueous medium consists of water, the water to be used can be any water available such as tap water and/or deionised water, preferably deionised water.

The aqueous medium may optionally comprise a protective colloid and/or an emulsifier in dissolved form. The aqueous medium used as initial charge is preferably heated to the temperature at which the copolymerization of the monomers is to take place, or to a temperature which is for example 10 to 15° C. below the copolymerization temperature. In the later case, the initiator portion to be initially charged can be added to the initial charge when the envisaged temperature, e.g. 10 to 15° C. below the copolymerization temperature, is reached. Alternatively, the initiator portion to be initially charged is included in the initial charge of the aqueous medium and then heated to the temperature at which the copolymerization of the monomers is to take place. Alternatively, the initiator portion is added to the initial charge of the aqueous medium at the temperature at which the copolymerization of the monomers is to take place. As soon as the particular copolymerization temperature desired is reached or within the time span of 1 to 15 minutes, preferably 5 to 15 minutes after reaching the copolymerization temperature, the metered addition of the monomers is commenced. They can be for example pumped into the reactor continuously within for example 60 minutes to 10 hours, usually within 2 to 4 hours. Adding the monomers in stages is also possible.

Copolymerization conditions are to be understood as meaning that the initially taken reaction mixture has been heated to the required temperature at which the copolymerization takes place. These temperatures are, for example, from 80 to 130° C., preferably from 90 to 120° C. The copolymerization is preferably carried out under pressure, for example at pressures up to 15 bar, e.g. from 2 to 10 bar.

It is a further requirement of the instant process that the copolymerization is carried out in the presence of at least one degraded starch.

For example, from 15 to 80% by weight, based on the total weight of monomers, of degraded starch are used in the copolymerization. All native starches, such as starches from corn, wheat, oats, barley, rice, millet, potatoes, peas, tapioca, sorghum or sago, are suitable as starting starches for the preparation of the degraded starches to be used according to the invention. Also of interest are those natural starches which have a high amylopectin content, such as waxy corn starch and waxy potato starch. The amylopectin content of these starches is above 90%, in general from 95 to 100%. Starches modified chemically by etherification or esterification can also be used for the preparation of the polymer dispersions according to the invention. Such products are known and are commercially available. They are prepared, for example, by esterification of a native starch or degraded native starch with inorganic or organic acids or anhydrides or chlorides thereof. Of particular interest are phosphated and acetylated degraded starches. The commonest method for etherifying starches consists in treating starch with organic halogen compounds, epoxides or sulfates in aqueous alkaline solution. Known starch ethers are alkyl ethers, hydroxyalkyl ethers, carboxyalkyl ethers and allyl ethers. Reaction products of starches with 2,3-epoxypropyltrimethylammonium chloride are also suitable. Degraded native starches, in particular native starches degraded to give maltodextrin, are particularly preferred. Further suitable starches are cationically modified starches, i.e. starch compounds which have amino groups or ammonium groups.

The degradation of the starches can be effected enzymatically, oxidatively or hydrolytically by the action of acids or bases. Degraded starches are commercially available. However, a natural starch can also, for example, first be degraded enzymatically in an aqueous medium and, after stopping of the enzymatic degradation in the aqueous solution or dispersion of the degraded starch prepared thereby, the copolymerization of the monomers can be carried out according to the invention. The degraded starches have, for example, an intrinsic viscosity ηi of less than 0.07 dl/g or less than 0.05 dl/g. The intrinsic viscosity ηi of the degraded starches is preferably in the range from 0.02 to 0.06 dl/g. The intrinsic viscosity ηi is determined according to DIN EN1628 at a temperature of 23° C.

The amounts of degraded starch which are used in the copolymerization are preferably from 15 to 80% by weight, preferably from 20 to 70% by weight, and more preferably from 25 to 65% by weight, based on the total weight of monomers.

The at least one degraded starch is preferably included in the initial charge of the aqueous medium which is heated to the temperature at which the copolymerization of the monomers is to take place.

It is a further requirement of the instant process that the copolymerization is carried out in the presence of free radical initiators.

Thus, initiators which form free radicals under the reaction conditions are used in the process according to the invention. Suitable free radical initiators are, for example, peroxides, hydroperoxides, hydrogen peroxide, sodium or potassium persulfate, redox catalysts and azo compounds, such as 2,2-azobis(4-methoxy-2,4-dimethylvaleronitrile), 2,2-azobis(2,4-dimethylvaleronitrile) and 2,2-azobis(2-amidinopropane) dihydrochloride. Examples of further suitable initiators are dibenzoyl peroxide, tert-butyl perpivalate, tert-butyl-per-2-ethyl hexanoate, di-tert-butyl peroxide, diamyl peroxide, dioctanoyl peroxide, didecanoyl peroxide, dilauroyl peroxide, bis(o-toluyl) peroxide, succinyl peroxide, tert-butyl peracetate, tert-butyl permaleate, tert-butyl perisobutyrate, tert-butyl perpivalate, tert-butyl peroctanoate, tert-butyl perbenzoate, tert-butyl hydroperoxide, azobisisobutyronitrile, 2,2′-azobis(2-methylbutyronitrile), 2,2′-azobis(2,4-dimethylvaleronitrile) and 2,2′-azobis(N,N′-dimethyleneisobutyramidine) dihydrochloride. Initiators selected from the group consisting of the peroxodisulfates, peroxosulfates, azo initiators, organic peroxides, organic hydroperoxides and hydrogen peroxide are preferred. Water-soluble initiators are particularly preferably used, e.g. sodium persulfate, potassium persulfate, ammonium persulfate, sodium peroxodisulfate, potassium peroxodisulfate and/or ammonium peroxodisulfate. The copolymerization can also be initiated with the aid of high-energy radiation, such as electron beams, or by irradiation with UV light.

The free radical initiators are used, for example, in amounts of up to 2% by weight, preferably of at least 0.5% by weight, e.g. from 0.8 to 1.5% by weight, based on the total weight of monomers.

In one embodiment, 0 to 15% by weight of the free radical initiators, based on the total weight of the free radical initiators, are initially mixed together with the degraded starch in the aqueous medium.

The amount of initiator in the initial charge is preferably not more than 15% by weight, usually not more than 12.5% by weight and most preferably not more than 10% by weight of the total amount required to copolymerize the monomers. The degraded starch effectuates good dispersal of the monomers and stabilization of the resulting finely divided polymers. In the course of the copolymerization, the degraded starch undergoes at least partial grafting and thereby becomes firmly incorporated in the resulting polymer.

Preferably, 0 to 15% by weight, e.g. 1 to 15% by weight, of the free radical initiators, based on the total weight of the free radical initiators, are mixed together with the degraded starch in the aqueous medium at a temperature which is for example 10 to 15° C. below the copolymerization temperature, and the remaining amount of the free radical initiators is then metered into this mixture under polymerization conditions, i.e. at the temperature at which the copolymerization of the monomers takes place.

Alternatively, the initial charge is free of the free radical initiators, i.e. the full amount of free radical initiators is metered into the mixture under polymerization conditions, e.g. at the temperature at which the copolymerization of the monomers takes place.

In one embodiment, at least 0.1% by weight, e.g. 0.1 to 10% by weight, of the monomers, based on the total weight of monomers, are mixed together with the degraded starch in the aqueous medium to obtain an intermediate starch/monomer mixture. 0 to 15% by weight, e.g. 1 to 15% by weight, of the free radical initiators, based on the total weight of the free radical initiators, are then mixed with the intermediate starch/monomer mixture at a temperature which is for example 10 to 15° C. below the copolymerization temperature, and then the remaining amount of monomers and the remaining amount of the free radical initiators is metered into this mixture under polymerization conditions, i.e. at the temperature at which the copolymerization of the monomers takes place.

The initial amount of monomers in the initial charge is preferably not more than 20% by weight, usually not more than 10% by weight, and most preferably from 0.1 to 10% by weight, e.g. from 0.2 to 10% by weight, based on the total weight of monomers.

After the copolymerization has completed, further free radical initiators may optionally be added to the reaction mixture and a postpolymerization is performed at the same temperature as the main polymerization or else at a lower or higher temperature. To complete the copolymerization reaction, it will in most cases sufficient to stir the reaction mixture at the copolymerization temperature for example 1 to 3 hours after addition of all the monomers.

The pH during the copolymerization of step a) can be for example in the range from 1 to 5. After polymerization, i.e. in the polymerization mixture obtained in step a), the pH is thus preferably in the range from 1 to 5.

In one embodiment, virtually coagulum-free aqueous dispersions are obtained in step a).

It is appreciated that the copolymerization of step a) is preferably an emulsion copolymerization and most preferably a free radical emulsion copolymerization.

In order to polymerize the monomers, an aqueous solution of the degraded starch can be provided. This solution may comprise, if appropriate, protective colloid and/or an emulsifier in dissolved form and, if appropriate, a latex seed such as a polystyrene seed. A detailed description of suitable protective colloids is given in Houben-Weyl, Methoden der organischen Chemie, volume XIV/1, Makromolekulare Stoffe, Georg-Thieme-Verlag, Stuttgart, 1961, pages 411 to 420. Suitable emulsifiers include surface-active substances whose number average molecular weight is typically below 2000 g/mol or preferably below 1500 g/mol, while the number average molecular weight of the protective colloids is above 2000 g/mol, for example in the range from 2000 to 100 000 g/mol and more particularly in the range from 5000 to 50 000 g/mol.

Suitable emulsifiers include, for example, ethoxylated C8-C36 fatty alcohols having a degree of ethoxylation in the range from 3 to 50, ethoxylated mono-, di- and tri-C4-C12-alkylphenols having a degree of ethoxylation in the range from 3 to 50, alkali metal salts of dialkyl esters of sulfosuccinic acid, alkali metal and ammonium salts of C8-C12 alkyl sulfates, alkali metal and ammonium salts of C12-C18 alkylsulfonic acids, alkali metal and ammonium salts of C9-C18 alkylarylsulfonic acids.

As further emulsifier, compounds of the general formula I

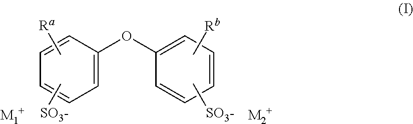

wherein R^{a} and R^{b} are each a H atom or C₄-C₂₄-alkyl and are not both H atoms at the same time, and M₁⁺ and M₂⁺ can be alkali metal ions and/or ammonium, are also useful. In the general formula I, R^{a} and R^{b} are preferably linear or branched alkyl radicals having from 6 to 18 carbon atoms, in particular 6, 12 or 16 carbon atoms, or hydrogen atoms, where R^{a} and R^{b} are not both hydrogen atoms at the same time. M₁⁺ and M₂⁺ are preferably sodium, potassium or ammonium, with sodium being particularly preferred. A compound of general formula I, in which M₁⁺ and M₂⁺ are both sodium, R^{a} is a branched alkyl radical having 12 carbon atoms and R^{b} is hydrogen or R^{a} is particularly advantageous. Use is frequently made of industrial mixtures which have a proportion of from 50 to 90% by weight of the monoalkylated product, for example Dowfwax® 2A1 (RTM the Dow Chemical Corp.). The compounds of general formula I are commonly known, e.g. from U.S. Pat. No. 4,269,749, and commercially available.

Cation-active emulsifiers are, for example, compounds having at least one amino or ammonium group and at least one C8-C22 alkyl group. When emulsifiers and/or protective colloids are used as auxiliaries to disperse the monomers, the amounts used thereof are for example in the range from 0.1% to 5% by weight, based on the total weight of monomers.

For modifying the properties of the polymers, the emulsion polymerization can optionally be carried out in the presence of at least one chain transfer agent. Examples of chain transfer agents are organic compounds comprising sulfur in bound form, such as dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea. Further chain transfer agents are aldehydes such as formaldehyde, acetaldehyde and propionaldehyde, organic acids such as formic acid, sodium formate or ammonium formate, alcohols such as isopropanol in particular and also phosphorus compounds such as sodium hypophosphite. Other suitable chain transfer agents are selected from hydrocarbon compounds such as terpenes, e.g. terpinolen. Suitable hydrocarbon compounds are also described in e.g. WO 2007/033930 A1, which is thus incorporated herewith by reference. T-Butylhydroperoxide is also described in the literature. Other suitable chain transfer agents are selected from rosins such as gum rosins, wood rosins or tall oil rosins. Suitable rosins are described in e.g. EP 707 672, which is thus incorporated herewith by reference.

When a chain transfer agent is used in the polymerization, the amount of chain transfer agent used in each case is for example in the range from 0.01% to 5% and preferably in the range from 0.1% to 1% by weight, based on the total weight of monomers. The chain transfer agents are preferably dosed in stages at different times to the monomers.

In one embodiment, the copolymerization of step a) is effected in the absence of emulsifier and/or chain transfer agents.

In the aqueous polymer dispersion obtained in step a), the dispersed particles have an average particle diameter of preferably 80 to 170 nm and more particularly 90 to 160 nm. The average particle diameter of the polymer particles can be determined by dynamic light scattering on a 0.005% to 0.01% by weight aqueous polymer dispersion at 23° C. by means of an Autosizer IIC from Malvern Instruments, England. The reported data are all based on the cumulant z-average diameter of the measured autocorrelation function as per ISO standard 13321.

In one embodiment, the solids content of the aqueous polymer dispersion obtained in step a) is more than 45% by weight, for example at least 50% by weight, based on the total weight of the polymer dispersion. A corresponding solids content can be effected for example through appropriate adjustment of the water quantity and/or the monomer quantities used in the emulsion polymerization.

In order to avoid a discoloration of the aqueous polymer dispersion, it is advantageous to treat the polymerization mixture of step a) with at least one reducing agent.

Thus, it is a specific requirement of the instant process that at least one reducing agent is added to the polymerization mixture of step a).

In one embodiment, the at least one reducing agent comprises, preferably consists of, one reducing agent. Alternatively, the at least one reducing agent comprises, preferably consists of, two or more reducing agents. For example, the at least one reducing agent comprises, preferably consists of, two or three reducing agents.

Preferably, the at least one reducing agent comprises, more preferably consists of, one reducing agent.

The at least one reducing agent is preferably selected from the group comprising sodium metabisulfite, sodium bisulfite, sodium dithionite, sodium hydroxymethylsulfinate, formamidinesulfinic acid, acetone sodium bisulfite, sodium hydrosulfite, sodium sulfite and mixtures thereof. More preferably, the at least one reducing agent is sodium metabisulfite and/or sodium bisulfate. Most preferably, the at least one reducing agent is sodium metabisulfite.

In order to achieve a sufficient reduction in the polymerization mixture, it is advantageous that the at least one reducing agent is added in an amount of at least 0.1% by weight, based on the total weight of monomers, to the polymerization mixture. Additionally or alternatively, an amount of more than 1% by weight, based on the total weight of monomers, of the at least one reducing agent which is added to the polymerization mixture is typically not required in order to avoid a discoloration of the aqueous polymer dispersion.

In one embodiment, the at least one reducing agent is thus added in an amount from 0.1 to 1% by weight, based on the total weight of monomers, to the polymerization mixture of step a). Preferably, the at least one reducing agent is added in an amount from 0.1 to 0.8% by weight, based on the total weight of monomers, to the polymerization mixture of step a). More preferably, the at least one reducing agent is added in an amount from 0.1 to 0.5% by weight, based on the total weight of monomers, to the polymerization mixture of step a).

The at least one reducing agent can be added during and/or after copolymerization step a), preferably after copolymerization step a). In case, the at least one reducing agent is added during copolymerization step a), it is appreciated that the at least one reducing agent can be added partially or completely during copolymerization step a). If the at least one reducing agent is added partially during copolymerization step a), it is preferred that the remaining portion is added after copolymerization step a). The at least one reducing agent can also be dosed in stages at different times during and/or after copolymerization step a).

If the at least one reducing agent is partially or completely added during copolymerization step a), it is appreciated that the at least one reducing agent is preferably added in the final stage of the copolymerization step a). For example, the at least one reducing agent is partially or completely added during copolymerization step a) only after the amount of unreacted monomers in the polymerization mixture has reached 20% or less. Preferably, the at least one reducing agent is partially or completely added during copolymerization step a) only after the amount of unreacted monomers in the polymerization mixture has reached a value of less than 15%. More preferably, the at least one reducing agent is partially or completely added during copolymerization step a) only after the amount of unreacted monomers in the polymerization mixture has reached a value in the range from 1 to 15%.

The term “after” copolymerization means that the copolymerization of step a) is completed. However, it does not exclude that a postpolymerization is carried out.

Thus, the at least one reducing agent is preferably added after copolymerization step a) is completed.

Preferably, a postpolymerization is carried out.

In case a postpolymerization is carried out, it is appreciated that the at least one reducing agent can be added during and/or after the postpolymerization of the polymerization mixture obtained in step a).

If the at least one reducing agent is added during the postpolymerization, it is appreciated that the at least one reducing agent can be added partially or completely during the postpolymerization. If the at least one reducing agent is added partially during the postpolymerization, it is preferred that the remaining portion is added after the postpolymerization. The at least one reducing agent can also be dosed in stages at different times during and/or after the postpolymerization.

In one embodiment, the at least one reducing agent is preferably added after the postpolymerization of the polymerization mixture obtained in step a) is completed.

The postpolymerization is preferably carried out at the same temperature at which the copolymerization of step a) takes place. These temperatures are, for example, from 70 to 130° C., preferably from 80 to 120° C.

The aqueous polymer dispersion obtained in step b) is preferably adjusted to a pH in the range from 5 to 8 and more preferably from 6 to 7. The adjustment of the pH can be obtained by every means known and typically used for adjusting a pH of an aqueous polymer dispersion. For example, the pH can be adjusted by using appropriate amounts of sodium hydroxide, e.g. an aqueous solution of sodium hydroxide or ammonia. The pH adjustment is preferably done at higher temperatures, preferably at temperatures in the range from 70 to 130° C., more preferably from 80 to 120° C., in order to stabilize the dispersion for further process steps without an additional cooling step.

In one embodiment, the solids content of the aqueous polymer dispersion obtained in step b) is more than 45% by weight, for example at least 50% by weight, based on the total weight of the polymer dispersion. A corresponding solids content can be effected for example through appropriate adjustment of the water quantity and/or the monomer quantities used in the emulsion polymerization.

As mentioned above, the aqueous polymer dispersion obtained by the instant process shows exceptional optical properties. In particular, process step b) prevents the aqueous polymer dispersion to undergo a visible discoloration. Thus, it is appreciated that the aqueous polymer dispersion obtained by the instant process does not show a visible discoloration.

For example, the aqueous polymer dispersion obtained in step b) provides when coated on a base paper with CIE brightness level of 90 to 100 in an application weight of 19 g/m² a decrease of CIE whiteness of less than 5 units, measured according to ISO 2469. Preferably, the aqueous polymer dispersion obtained in step b) provides when coated on a base paper with CIE brightness level of 90 to 100 in an application weight of 19 g/m² a decrease of CIE whiteness in the range of 2 to 5 units, measured according to ISO 2469.

The CIE whiteness provided by the aqueous polymer dispersion obtained in step b) when coated on a base paper with CIE brightness level of 90 to 100 in an application weight of 19 g/m² may be expressed by the following in equations.

In one embodiment, the CIE whiteness of the aqueous polymer dispersion obtained in step b) is improved compared to an aqueous polymer dispersion obtained by a process in which step b) is missing. In particular, it is appreciated that the improvement in CIE whiteness of the aqueous polymer dispersion obtained in step b) may be defined by in equation (I)

(CIE_{with step b})/(CIE_{without step b})≥1.05 (I)

wherein

(CIE_{with step b}) is the CIE whiteness provided by the aqueous polymer dispersion obtained in step b), when coated on a base paper with CIE brightness level of 90 to 100 in an application weight of 19 g/m², measured according to ISO 2469,

(CIE_{without step b}) is the CIE whiteness provided by an aqueous polymer dispersion obtained by a process in which step b) of the instant process is missing, when coated on a base paper with CIE brightness level of 90 to 100 in an application weight of 19 g/m², measured according to ISO 2469.

Preferably, the aqueous polymer dispersion obtained in step b) has a CIE whiteness as defined by in equation (Ia)

(CIE_{with step b})/(CIE_{without step b})≥1.10 (Ia)

wherein

(CIE_{with step b}) is the CIE whiteness provided by the aqueous polymer dispersion obtained in step b), when coated on a base paper with CIE brightness level of 90 to 100 in an application weight of 19 g/m², measured according to ISO 2469,

(CIE_{without step b}) is the CIE whiteness provided by an aqueous polymer dispersion obtained by a process in which step b) of the instant process is missing, when coated on a base paper with CIE brightness level of 90 to 100 in an application weight of 19 g/m², measured according to ISO 2469.

More preferably, the aqueous polymer dispersion obtained in step b) has a CIE whiteness as defined by in equation (Ib)

(CIE_{with step b})/(CIE_{without step b})≥1.15 (Ib)

wherein

(CIE_{with step b}) is the CIE whiteness provided by the aqueous polymer dispersion obtained in step b), when coated on a base paper with CIE brightness level of 90 to 100 in an application weight of 19 g/m², measured according to ISO 2469,

(CIE_{without step b}) is the CIE whiteness provided by an aqueous polymer dispersion obtained by a process in which step b) of the instant process is missing, when coated on a base paper with CIE brightness level of 90 to 100 in an application weight of 19 g/m², measured according to ISO 2469.

For example, the aqueous polymer dispersion obtained in step b) has a CIE whiteness as defined by in equation (Ic), preferably by in equation (Id) and most preferably by in equation (Ie)

1.05≤(CIE_{with step b})/(CIE_{without step b})≤2.0 (Ic)

1.10≤(CIE_{with step b})/(CIE_{without step b})≤2.0 (Id)

1.15≤(CIE_{with step b})/(CIE_{without step b})≤2.0 (Ie)

wherein

(CIE_{with step b}) is the CIE whiteness provided by the aqueous polymer dispersion obtained in step b), when coated on a base paper with CIE brightness level of 90 to 100 in an application weight of 19 g/m², measured according to ISO 2469,

(CIE_{without step b}) is the CIE whiteness provided by an aqueous polymer dispersion obtained by a process in which step b) of the instant process is missing, when coated on a base paper with CIE brightness level of 90 to 100 in an application weight of 19 g/m², measured according to ISO 2469.

In view of the advantages obtained, the present invention is thus further directed to an aqueous polymer dispersion obtained by a process as defined herein.

The present invention is further directed to a binder, an adhesive, a size suitable for at least one type of fiber, a paint, a covering, or a paper coating slip, comprising the aqueous polymer dispersion.

The present invention is also directed to the use of the aqueous polymer dispersion for the preparation of a binder, an adhesive, a size suitable for at least one type of fiber, a paint, a covering, or a paper coating slip.

The aqueous polymer dispersions according to the invention are suitable both for the sizing of textile fibers and for the sizing of mineral fibers, in particular glass fibers. Owing to their good optical properties they can also be used as an adhesive and for the production of coverings. Preferably, the aqueous polymer dispersions according to the invention are used as a paper coating slip or as a paint.

In addition to water, paper coating slips or paints generally further comprise pigments, binders and assistants for establishing the required rheological properties, e.g. thickeners. The pigments are usually dispersed in water. The paper coating slip or paint comprises pigments in an amount of, preferably, at least 80% by weight, e.g. from 80 to 95% by weight or from 80 to 90% by weight, based on the total solids content. In particular, white pigments are suitable. Suitable pigments are, for example, metal salt pigments, such as, for example, calcium sulfate, calcium aluminate sulfate, barium sulfate, magnesium carbonate and calcium carbonate, of which carbonate pigments, in particular calcium carbonate, are preferred. The calcium carbonate may be natural ground calcium carbonate (GCC), precipitated calcium carbonate (PCC), lime or chalk. Suitable calcium carbonate pigments are available, for example, as Covercarb® 60, Hydrocarb® 60 or Hydrocarb® 90 ME. Further suitable pigments are, for example silicic acids, aluminum oxides, aluminum hydroxide, silicates, titanium dioxide, zinc oxide, kaolin, alumina, talc or silicone dioxide. Suitable further pigments are available, for example, as Capim® MP 50 (Clay), Hydragloss® 90 (Clay) or Talcum 010.

The paper coating slip or paint comprises at least one binder. The aqueous polymer dispersion prepared according to the invention can be used in the paper coating slip or paint as the sole binder or in combination with further binders. The most important functions of binders in paper coating slips are to bind the pigments to the paper and the pigments to one another. For example, from 1 to 50% by weight, preferably from 1 to 25% by weight or from 3 to 20% by weight, based on the total weight of pigment, of an organic binder are used (solid, i.e. without water or other solvents which are liquid at 21° C., 1 bar).

Suitable further binders are binders having a natural base, in particular starch-based binders, and synthetic binders differing from the polymers prepared according to the invention, in particular emulsion polymers which can be prepared by emulsion polymerization. In this context, starch-based binders are to be understood as meaning any native, modified or degraded starch. Native starches may consist of amylose, amylopectin or mixtures thereof. Modified starches may be oxidized starch, starch esters or starch ethers. The molecular weight of the starch can be reduced by hydrolysis (degraded starch). Oligosaccharides or dextrins are suitable degradation products. Preferred starches are cereal, corn and potato starch. Cereal and corn starch are particularly preferred and corn starch is very particularly preferred.

The further synthetic binders differing from the polymers prepared according to the invention preferably comprise at least 40% by weight, preferably at least 60% by weight, particularly preferably at least 80% by weight, based on the total weight of the synthetic binder, of so-called main monomers. The main monomers are selected from C1-C20-alkyl (meth)acrylates, vinyl esters of carboxylic acids comprising up to 20 carbon atoms, vinylaromatics having up to 20 carbon atoms, ethylenically unsaturated nitriles, vinyl ethers of alcohols comprising 1 to 10 carbon atoms, aliphatic hydrocarbons having 2 to 8 carbon atoms and one or two double bonds or mixtures of these monomers. Alkyl (meth)acrylates having a C1-C10-alkyl radical, such as methyl methacrylate, methyl acrylate, n-butyl acrylate, ethyl acrylate and 2-ethylhexyl acrylate, may be mentioned by way of example. In particular, mixtures of the alkyl (meth)acrylates are also suitable. Vinyl esters of carboxylic acids having 1 to 20 carbon atoms are, for example, vinyl laurate, vinyl stearate, vinyl propionate, vinyl versatate and vinyl acetate. Suitable vinylaromatic compounds are vinyltoluene, α- and p-methylstyrene, α-butylstyrene, 4-n-butylstyrene, 4-n-decylstyrene and preferably styrene. Examples of nitriles are acrylonitrile and methacrylonitrile. For example, vinyl methyl ether or vinyl isobutyl ether may be mentioned as vinyl ethers. Vinyl ethers of alcohols comprising 1 to 4 carbon atoms are preferred. Ethylene, propylene, butadiene, isoprene and chloroprene may be mentioned as hydrocarbons having 2 to 8 carbon atoms and one or two olefinic double bonds.

Preferred main monomers are C1-C10-alkyl (meth)acrylates and mixtures of alkyl (meth)acrylates with vinylaromatics, in particular styrene, or hydrocarbons having two double bonds, in particular butadiene, or mixtures of such hydrocarbons with vinylaromatics, in particular styrene. In the case of mixtures of aliphatic hydrocarbons (in particular butadiene) with vinylaromatics (in particular styrene), the ratio may be, for example, from 10:90 to 90:10, in particular from 20:80 to 80:20. Particularly preferred main monomers are butadiene and the above mixtures of butadiene and styrene.

In addition to the main monomers, the emulsion polymer which is suitable as a binder may comprise further monomers, for example monomers having carboxyl, sulfo or phosphonic acid groups. Carboxyl groups are preferred. For example, acrylic acid, methacrylic acid, itaconic acid, maleic acid or fumaric acid may be mentioned. The content of ethylenically unsaturated acids in the emulsion polymer is in general less than 10% by weight, preferably less than 8% by weight and at least 0.1% by weight or at least 1% by weight, based on the total weight of the emulsion polymer. Further monomers are, for example, also monomers comprising hydroxyl groups, in particular C1-C10-hydroxyalkyl (meth)acrylates, or amides, such as (meth)acrylamide.

With the use of synthetic binders, natural binders, such as starch, can also be concomitantly used but are not absolutely essential.

Paper coating slips or paints according to the invention may additionally comprise further additives and assistants, for example fillers, cobinders and thickeners for further optimization of viscosity and water retention, optical brighteners, dispersants, surfactants, lubricants (e.g. calcium stearate and waxes), neutralizing agents (e.g. NaOH or ammonium hydroxide) for pH adjustment, antifoams, deaerating agents, preservatives (e.g. biocides), leveling agents, dyes (in particular soluble dyes), etc. Suitable thickeners in addition to synthetic polymers (e.g. crosslinked polyacrylate) are in particular celluloses, preferably carboxymethylcellulose. Optical brighteners are, for example, fluorescent or phosphorescent dyes, in particular stilbenes.

The paper coating slip is preferably an aqueous paper coating slip; it comprises water, in particular through the form of preparation of the constituents itself (aqueous polymer dispersions, aqueous pigment slurries); the desired viscosity can be established by addition of further water. Customary solids contents of the paper coating slips are in the range from 30 to 70% by weight, based on the total weight of the paper coating slip. The pH of the paper coating slip is preferably adjusted to values of from 6 to 10, in particular from 7 to 9.5.

An embodiment of the invention relates to a paper coating slip, the polymers of the aqueous polymer dispersion prepared according to the invention being used in an amount of from 1 to 50% by weight, based on the total amount of pigments, and the pigments being present in an amount of from 80 to 98% by weight, based on the total solids content, and being selected from the group consisting of calcium sulfate, calcium aluminate sulfate, barium sulfate, magnesium carbonate, calcium carbonate, silicic acids, aluminium oxides, aluminium hydroxide, silicates, titanium dioxide, zinc oxide, kaolin, alumina, talc and silicone dioxide, and the paper coating slip additionally comprising at least one assistant selected from the group consisting of thickeners, further polymeric binders, cobinders, optical brighteners, fillers, leveling agents, dispersants, surfactants, lubricants, neutralizing agents, antifoams, deaerating agents, preservatives and dyes.

The invention also relates to paper or cardboard coated with a paper coating slip according to the invention and to a process for coating paper or cardboard, an aqueous polymer dispersion being prepared according to the invention; and a paper coating slip being prepared with this polymer dispersion, at least one pigment and optionally further assistants; and the paper coating slip being applied to at least one surface of paper or cardboard.

The paper coating slip is preferably applied to uncoated base papers or uncoated cardboard. The amount is in general from 1 to 50 g, preferably from 5 to 30 g (solid, i.e. without water or other solvents which are liquid at 21° C., 1 bar) per square meter. The coating can be effected by customary application methods, for example by means of a size press, film press, blade coater, airbrush, air knife coater, curtain coating method or spray coater. Depending on the pigment system, the aqueous dispersions of the water-soluble copolymers in paper coating slips can be used for the basecoat and/or for the topcoat.

The scope and interest of the invention will be better understood based on the following examples which are intended to illustrate certain embodiments of the invention and are non-limitative.

### EXAMPLES

Unless evident otherwise from the context, the data in percent are always percent by weight. A stated content relates to the content in aqueous solution or dispersion.

The solids contents are determined by drying a defined amount of the respective aqueous copolymer dispersion (about 5 g) at 140° C. in a drying oven for 30 minutes. In each case two separate measurements are carried out and the mean value is calculated.

The glass transition temperature is determined according to DIN 53765 by means of a DSCQ 2000 apparatus, Series TA8000, from Mettler-Toledo Int. Inc.

The amount of coagulum in the dispersion is based on particles whose diameter is >45 μm. It is determined by filtering the prepared dispersion through a sieve having a known pore diameter.

The average particle diameters of the polymer particles are determined by dynamic light scattering on a 0.005 to 0.01% strength by weight aqueous polymer dispersion at 23° C. by means of an Autosizer IIC from Malvern Instruments, England. The average diameter of the cumulant evaluation (cumulant z-average) of the measured autocorrelation function (ISO standard 13321) is stated.

The intrinsic viscosity ni is determined according to DIN EN.1628 at a temperature of 23° C.

The CIE whiteness is determined according to ISO 2469.

### Example 1a (Comparative)

Into a 6 L pressurized reactor, fitted with 3 metering units and a MIG stirrer, 712 g deionized water, 806 g of degraded starch A and 5% by weight of the feeds 1A and 1B were initially added at room temperature under nitrogen atmosphere. Then the reactor content was heated to a temperature of 90° C. under stirring (180 rpm). When the temperature of 85° C. was reached, 129 g of a 7% strength by weight aqueous sodium persulfate solution were added. After 10 min stirring at 90° C., starting at the same time, the remaining amount of feeds 1A and 1B were added continuously over a dosing period of 360 min and the feed 2 was added continuously over a dosing period of 390 min at constant volume flows into the reactor. Over the total metering time, the streams of feeds 1A and 1B were homogenized shortly before entering the reactor. Subsequently, the reactor content was allowed to postpolymerize for 2 hours at 90° C. Then, the pH of the reactor content was adjusted to a pH of 6.5 by using a 15% strength by weight of aqueous sodium hydroxide solution. Finally, the reactor content was allowed to cool to room temperature and the pressure reactor was let down to atmospheric pressure.

The obtained aqueous polymer dispersion had a solids content of about 52% by weight, based on the total weight of the dispersion and contained 21 ppm coagulum. The glass transition temperature was determined as 10° C. and the average particle size as 127 nm.

In table 1 below, the compositions of feeds 1A, 1B and 2 are shown.

TABLE 1
Feed 1A
671 g deionized water
12 g of a 15% strength by weight aqueous sodium dodecyl sulfate solution
72 g acrylic acid
9 g itaconic acid
Feed 1B
1026 g styrene
21 g tert.-dodecyl mercaptan
693 g 1,3-butadiene
Feed 2
360 g of a 3.5% strength by weight aqueous sodium persulfate solution

### Example 1 b (Inventive)

An aqueous polymer dispersion was prepared in accordance with example 1a. However, following postpolymerization, 40 g of 13% strength by weight of an aqueous sodium metabisulfite solution were added into the reactor and then the pH of the reactor content was adjusted to a pH of 6.5 by using 15% strength by weight of aqueous sodium hydroxide solution. Finally, the reactor content was allowed to cool to room temperature and the pressure reactor was let down to atmospheric pressure.

The obtained aqueous polymer dispersion had a solids content of about 52% by weight, based on the total weight of the dispersion and contained 21 ppm coagulum. The glass transition temperature was determined as 10° C. and the average particle size as 127 nm.

### Example 2a (Comparative)

Into a 2 l glass reactor reactor, fitted with 3 metering units and a MIG stirrer, 304 g deionized water, 150 g degraded starch (C*Sweet 01403), 20 g of a 33% strength by weight of an aqueous latex seed (average particle size 30 nm), 35.7 g of a 7% strength by weight of an aqueous itaconic acid solution and 21.4 g of a 7% strength by weight of an aqueous sodium peroxodisulfate solution were initially added at room temperature and nitrogen atmosphere. Then, the reactor content was heated to a temperature of 92° C. under stirring (180 rpm). When the temperature was reached, starting at the same time, the feed 1 was added continuously over a dosing period of 180 min and the feed 2 was added continuously over a dosing period of 210 min at constant volume flows into the reactor. Subsequently, the reactor content was allowed to postpolymerize for 30 min at 90° C. Then, the pH of the reactor content was adjusted to a pH of 6.5 by using a 15% strength by weight aqueous sodium hydroxide solution. Finally, the reactor content was allowed to cool to room temperature.

The obtained aqueous polymer dispersion had a solids content of about 50.1% by weight, based on the total weight of the dispersion and was substantially free of coagulums. The particles had an average particle size of 150 nm.

In table 2 below, the compositions of inlets 1 and 2 are shown.

TABLE 2
Feed 1
275 g n-butylacrylate
108 g styrene
15 g acrylic acid
The components are emulsified in 207 g deionized water and 11 g Dowfax
2A1
Feed 2
50 g of a 7% strength by weight aqueous sodium peroxodisulfate solution

### Example 2b (Inventive)

An aqueous polymer dispersion was prepared in accordance with example 2a. However, following postpolymerization, 8 g of 13% strength by weight of an aqueous sodium metabisulfite solution were added into the reactor and then the pH of the reactor content was adjusted to a pH of 6.5 by using 15% strength by weight of aqueous sodium hydroxide solution. Finally, the reactor content was allowed to cool to room temperature.

The obtained aqueous polymer dispersion had a solids content of about 50.1% by weight, based on the total weight of the dispersion and was substantially free of coagulums. The particles had an average particle size of 150 nm.

### Measurement of Whiteness of a Coated Paper

The aqueous polymer dispersions of comparative examples 1a and 2a show a brownish discoloration. In contrast thereto, the aqueous polymer dispersions of inventive examples 1 b and 2b show a white color. For quantifying the whiteness, the dispersions were applied undiluted on one side of a commercial wood-free sheet of paper with a CIE whiteness of 99 by using a laboratory coating machine. Then the paper was dried by means of a drying cabinet. The application weight was about 19 g/m². The CIE whiteness of the prepared papers was determined by using an Elrepho brightness tester.

The optical properties of the aqueous polymer dispersions of examples 1a, 1 b, 2a and 2b are summarized in table 3 below.

TABLE 3
Optical appearance

| Example | Appearance | CIE whiteness |
|---|---|---|
| Comparative example 1a | Brownish discoloration | 78.6 |
| Inventive example 1b | White color | 94.3 |
| Comparative example 2a | Brownish discoloration | 77.0 |
| Inventive example 2b | White color | 93.8 |

From table 3, it can be gathered that an aqueous polymer dispersion prepared by the process of the instant invention shows improved optical properties, enabling a higher CIE whiteness when coated to a base paper compared to an aqueous polymer dispersion being prepared by the same process but in which the polymer dispersion was not treated with at least one reducing agent.

### Example 3

The effect on the discoloration by adding the reductive agent at different dosing times to the polymerization mixture is demonstrated in the following: The basic recipe was kept constant for all examples, only the dosing time of reductive agent was modified.

### a) Example 3a (without Reductive Agent)

Into a 2 l glass reactor, fitted with 3 metering units and a MIG stirrer, 150 g deionized water, 146 g degraded starch (C*Sweet 01403), and 14 g of a 33% strength by weight of an aqueous latex seed (average particle size 30 nm) were initially added at room temperature and nitrogen atmosphere. Then, the reactor content was heated to a temperature of 93° C. under stirring (170 rpm). When the temperature had reached 80° C., 15 g of a 7% strength by weight of an aqueous sodium peroxodisulfate solution was added. When the temperature of 93° C. was reached, starting at the same time, the feed 1 was added continuously over a dosing period of 180 min and the feed 2 was added continuously over a dosing period of 210 min at constant volume flows into the reactor. Then, the pH of the reactor content was adjusted to a pH of 6.5 by using a 15% strength by weight aqueous sodium hydroxide solution. Subsequently, the reactor content was allowed to postpolymerize for 30 min at 90° C. Finally, the reactor content was allowed to cool to room temperature.

In table 4 below, the compositions of feeds 1 and 2 are shown.

TABLE 4
Feed 1
200 g n-butylacrylate
133 g styrene
17.5 g acrylic acid
The components are emulsified in 126 g deionized water and 4 g Dowfax
2A1
Feed 2
35 g of a 7% strength by weight aqueous sodium peroxodisulfate solution

### b) Example 3b (Reductive Agent in Preload)

10.7 g of an Acetonbisulfite solution of 13% strength were additionally given to the preload. The obtained aqueous polymer dispersion had solids content of about 52.0% by weight, based on the total weight of the dispersion and was substantially free of coagulums. The particles had an average particle size of 152 nm.

### c) Example 3c (Reductive Agent Added 10 Min Before End of Feed 1)

10.7 g of an Acetonbisulfite solution of 13% strength were added 10 min before end of feed 1. The obtained aqueous polymer dispersion had solids content of about 52.2% by weight, based on the total weight of the dispersion and was substantially free of coagulums. The particles had an average particle size of 131 nm.

### d) Example 3d (Reductive Agent Added 10 Min Before End of Feed 2)

10.7 g of an Acetonbisulfite solution of 13% strength were added 10 min before end of feed 2. The obtained aqueous polymer dispersion had solids content of about 52.5% by weight, based on the total weight of the dispersion and was substantially free of coagulums. The particles had an average particle size of 131 nm.

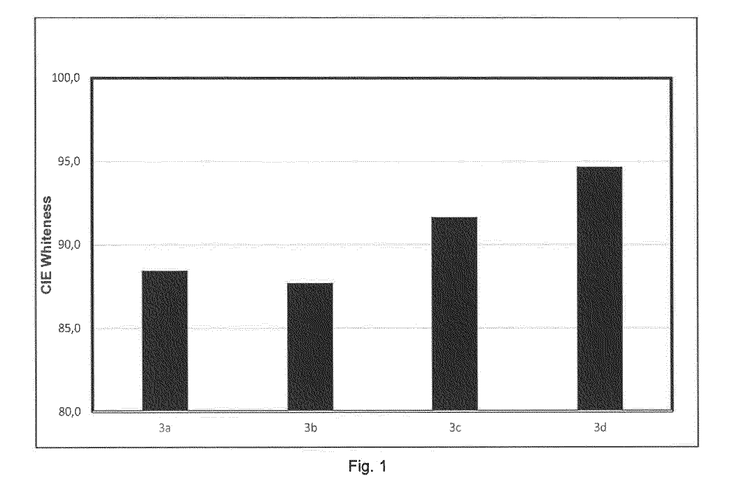

The optical properties of the aqueous polymer dispersions of examples 3a, 3b, 3c and 3d are summarized in table 5 and FIG. 1.

TABLE 5
Optical appearance

| Example | CIE whiteness |
|---|---|
| Example 3a | 88.4 |
| Example 3b | 87.7 |
| Example 3c | 91.6 |
| Example 3d | 94.7 |

From table 5 and FIG. 1, it can be gathered that an aqueous polymer dispersion prepared by the process of the instant invention shows improved optical properties, enabling a higher CIE whiteness when coated to a base paper compared to an aqueous polymer dispersion being prepared by the same process but in which the polymer dispersion was not treated with at least one reducing agent or in which the at least one reductive agent was added to the preload, i.e. the at least one reducing agent is not added to the polymerization mixture of step a). Furthermore, it can be gathered that the CIE whiteness can be further improved if the at least one reducing agent is added to polymerization mixture shortly before the addition of feed 2 is finished.

1. A process for preparing an aqueous polymer dispersion, the process comprising:
a) copolymerizing of
i) at least one vinyl aromatic compound,
ii) at least one ethylenically unsaturated acid, and at least one of
iii) at least one conjugated aliphatic diene,
iv) at least one acrylate monomer selected from a C1-C10 alkyl acrylate and a C1-C10 alkyl methacrylate, and
v) at least one unsaturated nitrogen containing compound,
in an aqueous medium in the presence of at least one degraded starch and at least one free radical initiator, to obtain a polymerization mixture; and
b) adding at least one reducing agent to the polymerization mixture, to obtain an aqueous polymer dispersion.

2. The process according to claim 1, wherein at least one of the following is satisfied:
the vinyl aromatic compound is selected from the group consisting of styrene, α-methylstyrene, vinyltoluene and mixtures thereof;
the at least one ethylenically unsaturated acid is selected from the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, vinylphosphonic acid, and salts thereof and mixtures thereof;
the at least one conjugated aliphatic diene is selected from the group consisting of 1,3-butadiene, isoprene, 1,3-pentadiene, dimethyl-1,3-butadiene, cyclopentadiene and mixtures thereof;
the at least one acrylate monomer is selected from the group consisting of methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, sec-butyl acrylate, sec-butyl methacrylate, tert-butyl acrylate, tert-butyl methacrylate, a pentyl acrylate, a pentyl methacrylate, 2-ethylhexyl acrylate, 2-ethylhexyl methacrylate, propylheptyl acrylate and mixtures thereof; and
the at least one unsaturated nitrogen containing monomer is selected from the group consisting of acrylamide, methacrylamide, diacetonacrylamide, acrylonitrile, methacrylonitrile, fumarnitrile and mixtures thereof.

3. The process according to claim 1, wherein the copolymerizing satisfies at least one of the following proportions:
i) 19.9 to 80% by weight, based on a total weight of monomers, of the at least one vinyl aromatic compound;
ii) 0.1 to 10% by weight, based on the total weight of monomers, of the at least one ethylenically unsaturated acid;
iii) 19.9 to 80% by weight, based on the total weight of monomers, of the at least one conjugated aliphatic diene;
iv) 19.9 to 80% by weight, based on the total weight of monomers, of the at least one acrylate monomer; and
v) 0 to 15% by weight, based on the total weight of monomers, of the at least one unsaturated nitrogen containing monomer,
the sum of the % by weight of the monomers i), ii), iii), iv) and v) always being 100.

4. The process according to claim 1, wherein the degraded starch comprises a degraded native starch having an intrinsic viscosity ηi of less than 0.07 dl/g.

5. The process according to claim 1, wherein the at least one degraded starch is present in an amount from 15 to 80% by weight, based on a total weight of monomers.

6. The process according to claim 1, wherein the at least one reducing agent is added into a polymer dispersion obtained after the copolymerization is completed.

7. The process according to claim 1, wherein the at least one reducing agent is selected from the group consisting of sodium metabisulfite, sodium bisulfite, sodium dithionite, sodium hydroxymethylsulfinate, formamidinesulfinic acid, acetone sodium bisulfite, sodium hydrosulfite, sodium sulfite and mixtures thereof.

8. The process according to claim 1, further comprising adjusting a pH of the aqueous polymer dispersion to a pH ranging from 5 to 8.

9. The process according to claim 1, wherein the aqueous polymer dispersion has a solids content of greater than 45% by weight, based on a total weight of polymer dispersion.

10. The process according to claim 1, wherein the aqueous polymer dispersion, when coated on a base paper with CIE brightness level of 90 to 100 in an application weight of 19 g/m², provides a decrease of CIE whiteness of less than 5 units, measured according to ISO 2469.

11. An aqueous polymer dispersion obtained by the process of claim 1.

12. A composition, comprising the aqueous polymer dispersion of claim 11, said composition being selected from the group consisting of a binder, an adhesive a size for at least one type of fiber and a paint.

13. An article, comprising the aqueous polymer dispersion according to claim 11, said article being a covering, or a paper coating slip.
